(19) United States
(12) Patent Application Publication
(10) Pub. No.: US 2026/0086537 A1
(43) Pub. Date: Mar. 26, 2026

(54) CHARACTERISTIC PREDICTION METHOD, METHOD OF MANUFACTURING SEMICONDUCTOR DEVICE, RECORDING MEDIUM OF CHARACTERISTIC PREDICTION PROGRAM, CHARACTERISTIC PREDICTION APPARATUS, AND TRAINED MODEL GENERATION METHOD

(71) Applicant: SUMITOMO ELECTRIC INDUSTRIES, LTD., Osaka (JP)

(72) Inventor: Shunsuke HOSOUMI, Osaka (JP)

(21) Appl. No.: 19/285,222

(22) Filed: Jul. 30, 2025

(30) Foreign Application Priority Data
Sep. 24, 2024 (JP) 2024-165537

(51) Int. Cl. G05B 19/418

(52) U.S. Cl. CPC G05B 19/4183; G05B 2219/32335; G05B 2219/45031

(57) ABSTRACT

A characteristic prediction method includes acquiring a trained model defining an association between a serial number and a characteristic, the serial number being based on a time-series arrangement of first processes executed by a processing apparatus and an arrangement order of wafers, the arrangement order of the wafers being determined in the processing apparatus, the processing apparatus arranging the wafers and simultaneously executing the first process, the characteristic being measured in each of the wafers after a second process is executed on the wafers on which the first process has been executed, and inputting, into the trained model, first serial numbers and measured first characteristics corresponding to the first serial numbers to predict second characteristics corresponding to second serial numbers after the first serial numbers. The trained model includes a time-series model using the serial number as a time series.

### CROSS REFERENCE TO RELATED APPLICATIONS

This application is based on and claims priority to Japanese Patent Application No. 2024-165537 filed on Sep. 24, 2024, and the entire contents of the Japanese patent application are incorporated herein by reference.

### TECHNICAL FIELD

The present disclosure relates to a characteristic prediction method, a method of manufacturing a semiconductor device, a recording medium of a characteristic prediction program, a characteristic prediction apparatus, and a trained model generation method.

### BACKGROUND

In a manufacturing system, a system is known that stores previously stored data in a time series and predicts data missing in the time series from the previously stored data (for example, Patent Literature: Japanese Unexamined Patent Application Publication No. 2022-162994).

### SUMMARY

An embodiment of the present disclosure is a characteristic prediction method that includes acquiring a trained model defining an association between a serial number and a characteristic, the serial number being based on a time-series arrangement of a plurality of first processes executed by a processing apparatus and an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed, and inputting, into the trained model, first serial numbers of a plurality of wafers in the first process executed by the processing apparatus and measured first characteristics corresponding to the first serial numbers to predict second characteristics corresponding to second serial numbers after the first serial numbers. The trained model includes a time-series model using the serial number as a time series.

An embodiment of the present disclosure is a method of manufacturing a semiconductor device, and the method includes performing the characteristic prediction method described above, changing a condition of the first process or the second process based on the second characteristics, and executing the first process or the second process on wafers corresponding to the second serial numbers by using the changed condition.

An embodiment of the present disclosure is a trained model generation method that includes acquiring training data in which a serial number is associated with a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed, and by performing machine learning on the training data, generating a trained model for predicting, by receiving an input of first serial numbers of a plurality of wafers in the first process executed by the processing apparatus and measured first characteristics corresponding to the first serial numbers, second characteristics corresponding to second serial numbers after the first serial numbers. The trained model includes a time-series model using the serial number as a time series.

The present disclosure can be implemented not only as the characteristic prediction method and the trained model generation method, but also as a characteristic prediction program, a characteristic prediction apparatus, a trained model generation program, and a trained model generation apparatus that process the characteristic steps. The present disclosure can also be implemented as a semiconductor integrated circuit that implements a part or all of the characteristic prediction apparatus and the trained model generation apparatus, or as an estimation system including the estimation apparatus.

### BRIEF DESCRIPTION OF THE DRAWINGS

FIG. 1 is a flowchart of a process for predicting a characteristic in a first embodiment.

FIG. 2 is a cross-sectional view illustrating a step in a method of manufacturing a nitride semiconductor device.

FIG. 3 is a cross-sectional view illustrating a step in the method of manufacturing the nitride semiconductor device.

FIG. 4 is a plan view illustrating batch processing in the first embodiment.

FIG. 5 is a block diagram of a system including a characteristic prediction apparatus and a trained model generation apparatus according to the first embodiment.

FIG. 6 is a block diagram of an information processing apparatus in the first embodiment.

FIG. 7 is a functional block diagram of the trained model generation apparatus according to the first embodiment.

FIG. 8 is a table indicating a data array of training data in the first embodiment.

FIG. 9 is a functional block diagram of the characteristic prediction apparatus according to the first embodiment.

FIG. 10 is a table indicating a data array of input data in the first embodiment.

FIG. 11 is a table indicating a data array of predicted data in the first embodiment.

FIG. 12 is a diagram illustrating an arrangement order of wafers in a prediction example.

FIG. 13 is a diagram illustrating a prediction model used in the prediction example.

FIG. 14 is a diagram illustrating processing of the prediction model in a time series in the prediction example. 25

FIG. 15 is a diagram illustrating the processing of the prediction model in a time series in the prediction example.

FIG. 16 is a graph indicating a leakage current with respect to serial numbers in the prediction example.

FIG. 17 is a graph indicating a leakage current with respect to serial numbers in the prediction example.

FIG. 18 is a diagram illustrating another example of an arrangement order of wafers.

FIG. 19 is a flowchart illustrating a method of manufacturing a semiconductor device according to a second embodiment.

### DETAILED DESCRIPTION

After a wafer is processed, another process may be performed to measure a characteristic of the wafer. In such a case, in a processing apparatus that processes a plurality of wafers simultaneously, the characteristic may not be appropriately estimated only by arranging the plurality of wafers in a time series of processes.

The object of the present disclosure is to provide a characteristic prediction method, a method of manufacturing a semiconductor device, a recording medium of a characteristic prediction program, a characteristic prediction apparatus, and a trained model generation method, which are capable of appropriately predicting a characteristic.

According to the present disclosure, a characteristic can be appropriately predicted.

### Description of Embodiments of Present Disclosure

First, embodiments of the present disclosure will be listed and described.
(1) An embodiment of the present disclosure is a characteristic prediction method that includes acquiring a trained model defining an association between a serial number and a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed, and inputting, into the trained model, first serial numbers of a plurality of wafers in the first process executed by the processing apparatus and measured first characteristics corresponding to the first serial numbers to predict second characteristics corresponding to second serial numbers after the first serial numbers. The trained model includes a time-series model using the serial number as a time series. This makes it possible to appropriately predict the characteristic.
(2) In the above (1), the time-series model may include a long short-term memory (LSTM) model, a Transformer model, or a gated recurrent unit (GRU) model. This can improve the prediction accuracy of the characteristic.
(3) In the above (1) or (2), the first serial numbers, the second serial numbers, the first characteristics, and the second characteristics may be input into the trained model to predict third characteristics corresponding to third serial numbers after the second serial numbers. Thus, the third characteristic of the third serial number after the second serial number can be predicted.
(4) In any one of the above (1) to (3), the trained model may output a characteristic corresponding to a serial number a predetermined number of 2 or more later with respect to a serial number corresponding to an input characteristic. This can improve the prediction accuracy of the characteristic.
(5) In any one of the above (1) to (4), a number of the first serial numbers may be greater than or equal to a number of wafers on which the first process is executed by the processing apparatus simultaneously. This can improve the prediction accuracy of the characteristic.
(6) In any one of the above (1) to (5), the processing apparatus may be a semiconductor device manufacturing apparatus. This makes it possible to predict the characteristic of the semiconductor device with high accuracy.
(7) In any one of the above (1) to (5), the processing apparatus may be an epitaxial growth apparatus, the first process may form a semiconductor epitaxial layer on a substrate, the second process may include forming an electrode on the semiconductor epitaxial layer, and the characteristic may be an electrical characteristic measured using the electrode. This makes it possible to predict the characteristic of the semiconductor device with high accuracy.
(8) In the above (7), the semiconductor epitaxial layer may include a nitride semiconductor layer. This makes it possible to accurately predict the characteristics of the nitride semiconductor device.
(9) An embodiment of the present disclosure is a method of manufacturing a semiconductor device, and the method includes performing the characteristic prediction method according to any one of (1) to (8), changing a condition of the first process or the second process based on the second characteristics, and executing the first process or the second process on wafers corresponding to the second serial numbers by using the changed condition. This can improve the characteristics of the semiconductor device.
(10) An embodiment of the present disclosure is a non-transitory computer-readable recording medium having stored therein a characteristic prediction program for causing a computer to perform: acquiring a trained model defining an association between a serial number and a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed, and inputting, into the trained model, first serial numbers of a plurality of wafers in the first process executed by the processing apparatus and measured first characteristics corresponding to the first serial numbers to predict second characteristics corresponding to second serial numbers after the first serial numbers. The trained model includes a time-series model using the serial number as a time series. This makes it possible to appropriately predict the characteristic.
(11) An embodiment of the present disclosure is a characteristic prediction apparatus that includes a processor; and a memory storing program instructions that cause the processor to: acquire a trained model defining an association between a serial number and a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed, and input, into the trained model, first serial numbers of a plurality of wafers in the first process executed by the processing apparatus and measured first characteristics corresponding to the first serial numbers to predict second characteristics corresponding to second serial numbers after the first serial numbers. The trained model includes a time-series model using the serial number as a time series. This makes it possible to appropriately predict the characteristic.
(12) An embodiment of the present disclosure is a trained model generation method includes acquiring training data in which a serial number is associated with a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed, and by performing machine learning on the training data, generating a trained model for predicting, by receiving an input of first serial numbers of a plurality of wafers in the first process executed by the processing apparatus and measured first characteristics corresponding to the first serial numbers, second characteristics corresponding to second serial numbers after the first serial numbers. The trained model includes a time-series model using the serial number as a time series. This makes it possible to appropriately predict the characteristic.
(13) An embodiment of the present disclosure is a characteristic prediction apparatus that includes a memory, and a processor. The processor is configured to acquire a trained model defining an association between a serial number and a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed, and configured to input, into the trained model, first serial numbers of a plurality of wafers in the first process executed by the processing apparatus and measured first characteristics corresponding to the first serial numbers to predict second characteristics corresponding to second serial numbers after the first serial numbers. The trained model includes a time-series model using the serial number as a time series. This makes it possible to appropriately predict the characteristic.

### Details of Embodiments of Present Disclosure

Specific examples of a characteristic prediction method, a method of manufacturing a semiconductor device, a characteristic prediction program, a characteristic prediction apparatus, and a trained model generation method according to embodiments of the present disclosure will be described below with reference to the drawings. It is noted that, the present disclosure is not limited to these examples, but is defined by the scope of the claims, and is intended to include all modifications within the meaning and scope equivalent to the scope of the claims.

At least some of the embodiments described below may be combined as desired. The characteristic prediction apparatus is configured to include a computer, and each function of the characteristic prediction apparatus is exhibited by a computer program stored in a storage device of the computer being executed by a central processing unit (CPU) of the computer. The computer program can be stored on a storage medium such as a CD-ROM (Compact Disc Read Only Memory) or a DVD (Digital Versatile Disc).

### First Embodiment

### (Description of Processing)

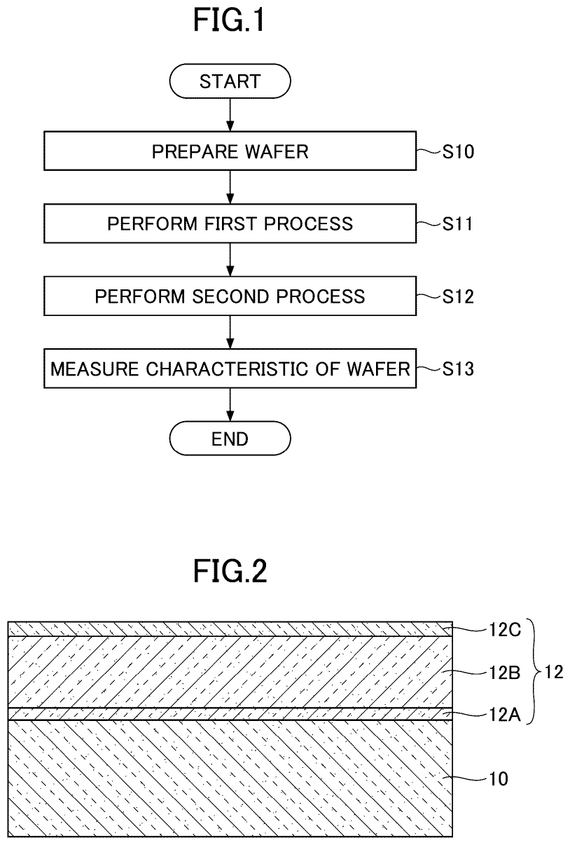

In a first embodiment, wafer processing for predicting a characteristic will be described. The wafer is, for example, a semiconductor wafer, and the wafer processing is, for example, a process in manufacturing processes of a semiconductor device. FIG. 1 is a flowchart of a process of predicting a characteristic in the first embodiment. As illustrated in FIG. 1, a wafer is prepared (step S10). The wafer is a wafer on which processes before a first process have been completed.

Next, the first process is performed (step S11). In the first process, a plurality of wafers are processed simultaneously. The first process is a process using, for example, a batch-type processing apparatus, and is, for example, a film forming process of growing a film on a wafer, an etching process of etching a part of a wafer, or a surface treatment of treating a surface of a wafer. For the film forming process, a film forming apparatus such as a chemical vapor deposition (CVD) apparatus or a physical vapor deposition (PVD) apparatus is used. For the etching process, an etching apparatus, such as a dry etching apparatus or a wet etching apparatus, is used. For the surface treatment, a plasma surface treatment apparatus using plasma or a surface treatment apparatus by wet treatment is used, for example.

Next, a second process is performed (step S12). In the second process, a film forming process, an etching process, or a surface treatment is performed on the wafer subjected to the first process. The second process may be a plurality of processes. For example, the second process includes a process of manufacturing a semiconductor device.

Next, the characteristic of the wafer is measured (step S13). The characteristic of the wafer is an electrical characteristic. For example, when the second process includes a process of forming electrodes, the characteristic of the wafer may be electrical characteristic that is electrically measured using the electrodes. The characteristic of the wafer may be a physical characteristic of the wafer, such as a width of a pattern, a depth of a pattern, or a thickness of a film. The characteristic of the wafer may be an optical characteristic, such as a refractive index. The characteristic of the wafer may be one type of characteristic or a plurality of types of characteristics. Thereafter, the process is completed. After completion, the wafer may be subjected to other processes.

### Manufacturing Example of Nitride Semiconductor Device

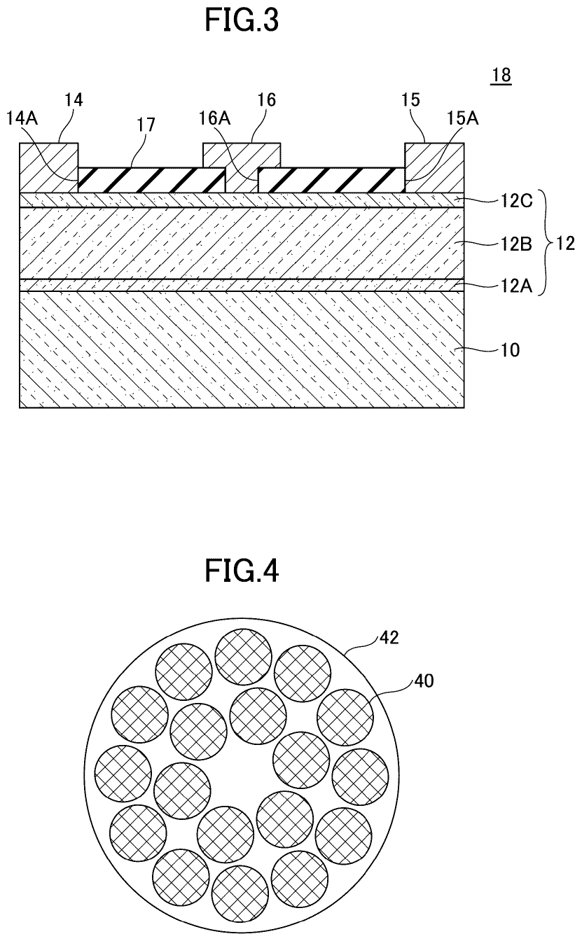

As an example of the wafer processing, a process of manufacturing a nitride semiconductor device will be described. FIG. 2 and FIG. 3 are cross-sectional views illustrating a method of manufacturing the nitride semiconductor device. As illustrated in FIG. 2, a substrate 10 is prepared as a wafer in step S10. The substrate 10 is, for example, a silicon carbide substrate, a sapphire substrate, or a diamond substrate.

As the first process of step S11, a semiconductor layer 12 is formed on the substrate 10 by using a metal organic CVD (MOCVD) method. The semiconductor layer 12 is, for example, a nucleation layer 12A, an electron transit layer 12B, and an electron supply layer 12C. The nucleation layer 12A is, for example, an aluminum nitride (AlN) layer. The electron transit layer 12B is, for example, a gallium nitride (GaN) layer. The electron supply layer 12C is, for example, an aluminum gallium nitride (AlGaN) layer. The gas used for growing the gallium nitride layer is, for example, trimethylgallium (TMG) gas and ammonia gas. The gas used for growing the aluminum nitride layer is, for example, trimethylaluminum (TMA) gas and ammonia gas. The gas used for growing the aluminum gallium nitride layer is, for example, TMA gas, TMG gas, and ammonia gas. Triethylaluminum gas and triethylgallium gas may be used instead of the TMA gas and the TMG gas, respectively.

Next, as illustrated in FIG. 3, as the second process of step S12, an insulating layer 17 is formed on the semiconductor layer 12. The insulating layer 17 is, for example, a silicon nitride layer, and is formed by CVD. Openings 14A and 15A are formed in the insulating layer 17. The openings 14A and 15A are formed by, for example, a photolithography method and an etching method. A source electrode 14 and a drain electrode 15 are formed in the openings 14A and 15A, respectively. The source electrode 14 and the drain electrode 15 are, for example, a titanium layer and an aluminum layer formed in this order on the semiconductor layer 12, and are formed by using a vacuum evaporation method and a lift-off method. An opening 16A is formed in the insulating layer 17 between the source electrode 14 and the drain electrode 15. The opening 16A is formed by using, for example, the photolithography method and the etching method. A gate electrode 16 is formed in the opening 16A. The gate electrode 16 is, for example, a nickel layer and a gold layer formed in this order on the semiconductor layer 12, and is formed using a vacuum evaporation method and a lift-off method.

As described above, a GaN HEMT (Gallium Nitride High Electron Mobility Transistor) is manufactured as a semiconductor device 18. As the measurement of step S13, the electrical characteristic of the semiconductor device 18 is measured. The electrical characteristic can be leakage current. The leakage current is measured as follows, for example. A negative voltage is applied to the gate electrode 16 to deplete the electron supply layer 12C and the upper portion of the electron transit layer 12B. A voltage (for example, 100 V) is applied between the source electrode 14 and the drain electrode 15, and a leakage current flowing between the source electrode 14 and the drain electrode 15 is measured.

When the number of processes of the second process is large as illustrated in FIG. 3, it may take one month or more from the execution of the first process to the measurement of the characteristic. In order to stably manufacture the semiconductor device 18, it may be required to predict the characteristic before the measurement of the characteristic in step S13. For example, when the predicted characteristic is not the desired characteristic, the actual characteristic can be made to be the desired characteristic by changing the condition of the first process or the second process.

The electrical characteristics of the GaN HEMT are affected by the growth of the semiconductor layer 12 of FIG. 2. For example, the leakage current is a current flowing through a region of the semiconductor layer 12 close to the substrate 10. Thus, the film quality of the semiconductor layer 12 affects the leakage current. Thus, the leakage current is predicted before or immediately after the semiconductor layer 12 is formed.

In the processing apparatus, the processing order may affect the characteristic. For example, in the MOCVD apparatus, a wafer 40 is introduced into a chamber, and a gas serving as a raw material is supplied, thereby forming the semiconductor layer 12 on the wafer 40. At this time, the film quality of the semiconductor layer 12 may change depending on the situation in the chamber. For example, when the semiconductor layer 12 is formed, a product adheres to the inside of the chamber. In the case where the film quality of the semiconductor layer 12 changes depending on the adhesion amount of the product, the film quality of the semiconductor layer 12 changes depending on the number of times of the processing, and the leakage current of the GaN HEMT changes. When the inside of the chamber is cleaned, the product in the chamber is removed, and thus the film quality of the semiconductor layer 12 is initialized and the leakage current is also initialized.

Thus, it is conceivable that based on past information in which the processing order in the processing apparatus is associated with the characteristic, an unknown characteristic can be predicted from a processing order. As described later, when the machine learning was performed on the information in which the processing order was associated with the characteristic and the characteristic was predicted from a processing order, the characteristic was greatly different from the actual characteristic. As the reason for this, an arrangement order in a batch-type processing apparatus is focused on.

FIG. 4 is a plan view illustrating batch processing in the first embodiment. FIG. 4 illustrates the arrangement of wafers in an MOCVD apparatus as a processing apparatus for performing the first process. The plurality of wafers 40 are arranged in a circular susceptor 42. The wafers 40 are arranged concentrically. Inside, there are six wafers 40 arranged in a circumferential shape, and outside of these, there are twelve wafers 40 arranged in a circumferential shape. FIG. 4 illustrates an example of batch processing, and the number and arrangement of the wafers 40 vary depending on the processing apparatus.

In the MOCVD apparatus, the film quality of the semiconductor layer 12 varies depending on the position of the wafer 40 due to the temperature distribution of the susceptor 42, the position where the gas as the raw material is introduced into the chamber, the position where the gas is exhausted from the chamber, and the like. Thus, it is conceivable that not only the processing order but also the arrangement order of the wafers 40 is important. As described later, when machine learning is performed on processing arrangement information in which the arrangement order is associated with the characteristic in addition to the processing order, and the characteristic is predicted from the processing order, a characteristic close to the actual characteristic can be predicted.

In a batch-type processing apparatus, such as a film forming apparatus other than the MOCVD apparatus, an etching apparatus, or a surface treatment apparatus, the first embodiment can be applied when the subsequent characteristic depends on the arrangement position of the wafer 40 or the like.

### Example of System

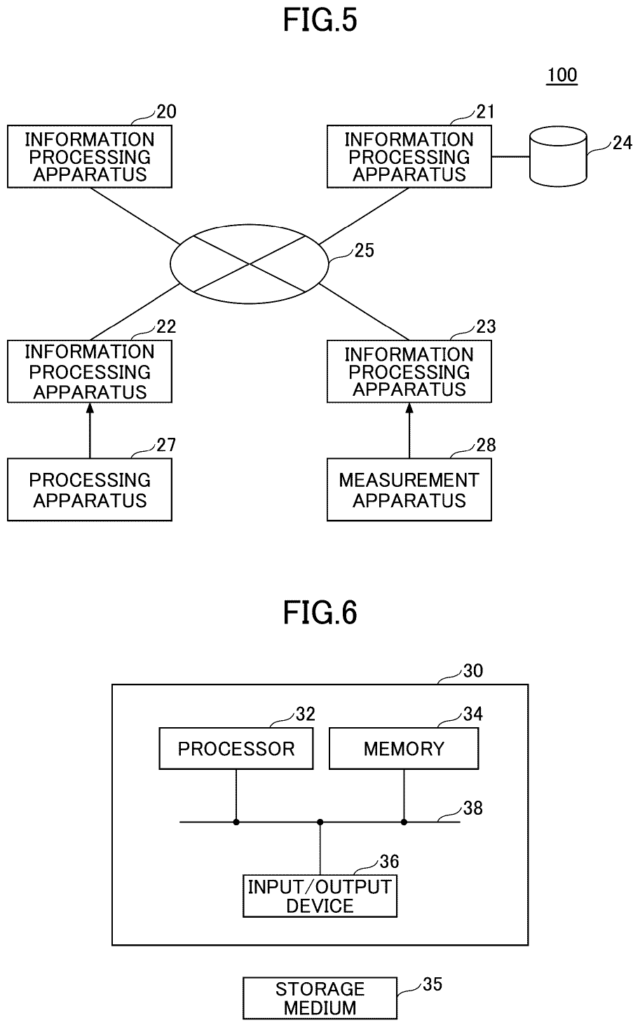

FIG. 5 is a block diagram of a system including a characteristic prediction apparatus and a trained model generation apparatus according to the first embodiment. As illustrated in FIG. 5, the characteristic estimation system of the first embodiment includes one or a plurality of information processing apparatuses 20 to 23. The information processing apparatuses 20 to 23 are, for example, computers, and may be portable or stationary. The information processing apparatuses 20 to 23 are connected to a network 25. The network 25 is, for example, a wireless or wired local area network (LAN). The information processing apparatus 20 is a terminal used by a user to predict a characteristic. The information processing apparatus 21 is a terminal to which a storage device 24 storing data, trained model, and the like is connected. The storage device 24 is, for example, a semiconductor storage device, an optical storage device, or a magnetic storage device. The information processing apparatus 22 is a terminal for inputting processing information, such as the processing order and arrangement order of a processing apparatus 27. The processing information may be automatically sent from the processing apparatus 27 to the information processing apparatus 22, or may be input to the information processing apparatus 22 by a user. The information processing apparatus 23 is a terminal to which the characteristic information measured by a measurement apparatus 28 is input. The characteristic information may be automatically sent from the measurement apparatus 28 to the information processing apparatus 23, or may be input to the information processing apparatus 23 by a user.

One information processing apparatus may serve as at least two of the information processing apparatuses 20 to 23. One information processing apparatus may serve as the information processing apparatuses 20 to 23.

### (Block Diagram of Computer)

FIG. 6 is a block diagram of the information processing apparatus in the first embodiment. A computer 30, which serves as the information processing apparatuses 20 to 23, includes a processor 32, a memory 34, an input/output device 36, and an internal bus 38. The processor 32 is, for example, a central processing unit (CPU), and executes a characteristic prediction program, a trained model generation program, a characteristic prediction method, and a trained model generation method (hereinafter, also simply referred to as a program and a method). The memory 34 is, for example, a volatile memory or a nonvolatile memory, and stores data and the like used when the processor 32 executes the program and the method. The memory 34 may store a program to be executed by the processor 32. The input/output device 36 inputs data acquired by the processor 32 from an external device, and outputs data output by the processor 32 to the external device. The external device is another computer, another program in the same computer, or the like. The internal bus 38 connects the processor 32, the memory 34, and the input/output device 36, and transmits data and the like. The program is stored in a storage medium 35. The storage medium 35 is, for example, a non-transitory tangible medium, such as a CD-ROM or a DVD.

### (Trained Model Generation)

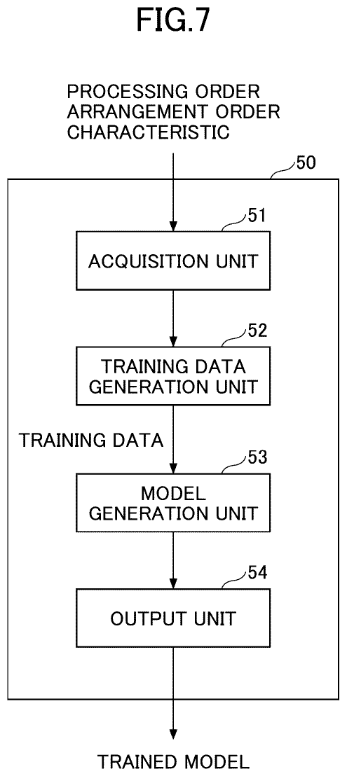

FIG. 7 is a functional block diagram of the trained model generation apparatus according to the first embodiment. As illustrated in FIG. 7, a trained model generation apparatus 50 includes an acquisition unit 51, a training data generation unit 52, a model generation unit 53, and an output unit 54. The information processing apparatus 21 functions as the acquisition unit 51, the training data generation unit 52, the model generation unit 53, and the output unit 54 in cooperation with a program.

The acquisition unit 51 acquires the processing order, the arrangement order, and the characteristic. The processing order is information indicating the time-series order in which the processing apparatus 27 has processed the wafers in step S11 of FIG. 1. The arrangement order is information indicating the position where the wafer is arranged in the processing apparatus 27 in step S11. The arrangement order is information on the position in the susceptor 42 where the wafer 40 is arranged in FIG. 4, for example. The characteristic is information on the characteristic of the wafer measured in step S13 after the second process in step S12 in FIG. 1.

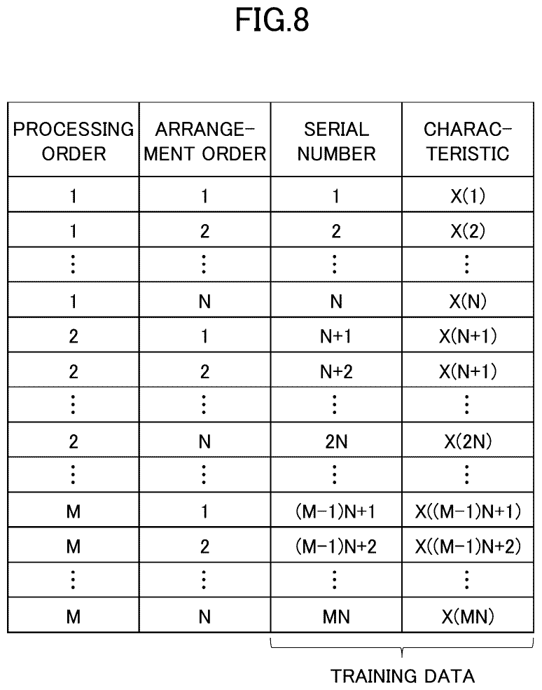

The training data generation unit 52 generates training data in which the serial number is associated with the characteristic based on the processing order, the arrangement order, and the characteristic. FIG. 8 is a table indicating a data array of the training data in the first embodiment. The “processing order” is the order of processing of the processing apparatus 27, and “1” indicates the first processing, “2” indicates the second processing, and “M” indicates the M-th processing. The “arrangement order” is the arrangement position of the wafer in the processing apparatus 27, and “1” indicates the first position, “2” indicates the second position, and “N” indicates the N-th position. The “serial number” is a number assigned to each of the wafers of the same processing that are arranged in an arrangement order. The training data generation unit 52 sets, to “1”, “2”, and “N”, the “serial numbers” of the wafers having the arrangement orders of “1”, “2”, and “N” in the processing order “1”. The training data generation unit 52 sets, to “(M−1)N+1”, “(M−1)N+2”, and “MN”, the “serial numbers” of the wafers having the arrangement orders of “1”, “2”, and “N” in the processing order of “M”. The “characteristic” is characteristic information of the wafer. The “characteristic” is X(1) to X(MN) according to the “processing order” and the “arrangement order”. The training data generation unit 52 generates training data in which 1 to MN as the “serial number” are associated with X(1) to X(MN) as the “characteristic”. The training data generation unit 52 may generate training data each time the processing order, the arrangement order, and the characteristic are acquired, or may generate training data for each certain period. The training data generation unit 52 stores the generated training data in the memory 34 or the storage device 24.

Returning to FIG. 7, the model generation unit 53 acquires the training data. The model generation unit 53 generates a trained model by performing machine learning on the training data. The model generation unit 53 generates a trained model using a time-series model with the serial number in the training data as a time series. The time-series model is, for example, a recurrent neural network (RNN). As the time-series model, for example, a long short term memory (LSTM) model, a transformer model, or a gated recurrent unit (GRU) model may be used as a model capable of long-term storage. The model generation unit 53 may generate the trained model each time the training data generation unit 52 generates the training data, or may generate the trained model at predetermined intervals. The model generation unit 53 functions in the information processing apparatus 21 in FIG. 5, for example.

The output unit 54 outputs the trained model generated by the model generation unit to the memory 34 or the storage device 24.

### (Characteristic Prediction)

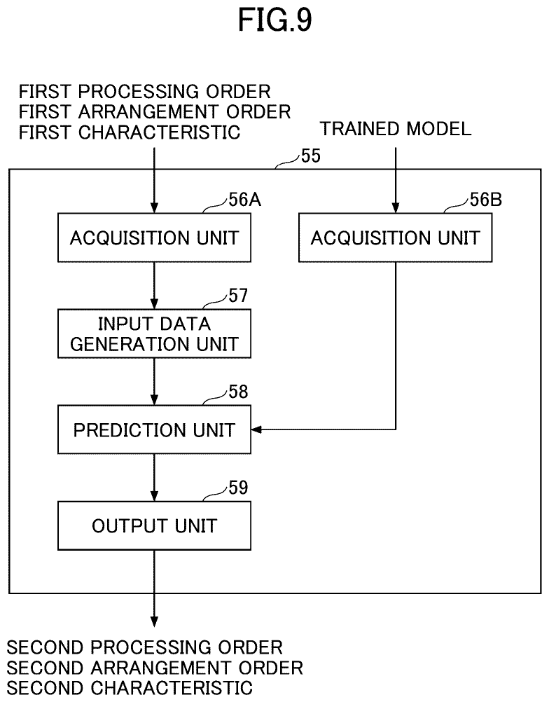

FIG. 9 is a functional block diagram of a characteristic prediction apparatus according to the first embodiment. As illustrated in FIG. 9, a characteristic prediction apparatus 55 includes acquisition units 56A and 56B, an input data generation unit 57, a prediction unit 58, and an output unit 59. The information processing apparatus 20 functions as the acquisition units 56A and 56B, the input data generation unit 57, the prediction unit 58, and the output unit 59 in cooperation with a program.

The acquisition unit 56A acquires a first processing order, a first arrangement order, and a first characteristic that are different from the processing order, the arrangement order, and the characteristic acquired by the acquisition unit 51 of the trained model generation apparatus 50. The first processing order includes a processing order after the processing order in FIG. 7. A part of the first processing order may overlap the processing order acquired by the acquisition unit 51. The input data generation unit 57 generates input data using the same method as the training data generation unit 52 generates training data.

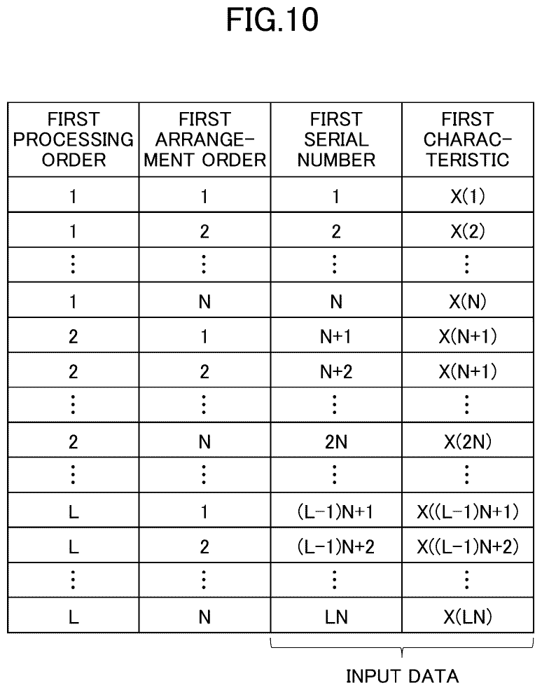

FIG. 10 is a table indicating a data array of input data in the first embodiment. The “first processing order” is “1” to “L”. The “first arrangement order” is “1” to “N”. The “first serial number” is “1” to “LN”. The “first characteristic” is X(1) to X(LN) according to the “first processing order” and the “first arrangement order”. The input data generation unit 57 generates input data in which 1 to LN as the “first serial number” are associated with X(1) to X(LN) as the “first characteristic”.

Referring back to FIG. 9, an acquisition unit 56B acquires the trained model from the memory 34 or the storage device 24. The prediction unit 58 acquires the input data and the trained model. The prediction unit 58 predicts a second characteristic for a second serial number by inputting the input data into the trained model.

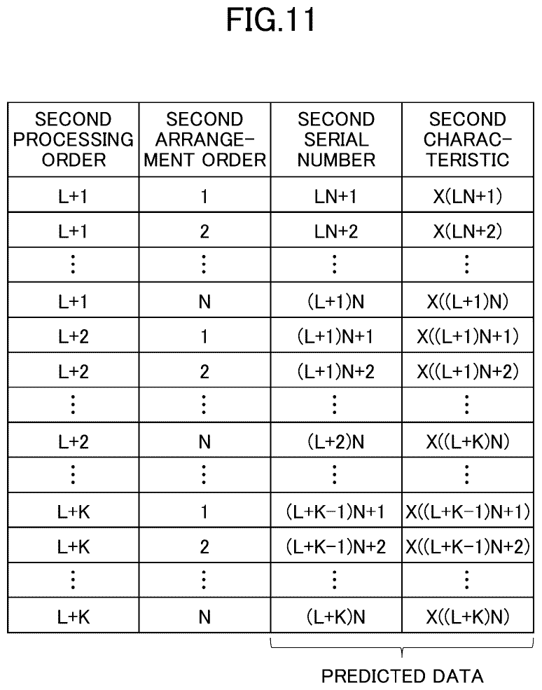

FIG. 11 is a table indicating a data array of predicted data in the first embodiment. A “second processing order” is from “L+1” to “L+K”. A “second arrangement order” is “1” to “N”. A “second serial number” is “LN+1” to “(L+K)N”. The “second characteristic” is X(LN+1) to X((L+K)N)) according to the “second processing order” and the “second arrangement order”. In this manner, the prediction unit 58 predicts the second characteristics X(LN+1) to X((L+K)N) corresponding to the second serial numbers LN+1 to (L+K)N in the processing order L+1 to L+K (the second processing order) after the last processing order L of the first processing order. The prediction unit 58 may expand the second serial number in the second processing order and the second arrangement order.

Referring back to FIG. 9, the output unit 59 outputs, to the external device or the storage device 24, the second characteristic predicted by the prediction unit 58 that corresponds to the second processing order and the second arrangement order.

### Prediction Example

A prediction example will be described in which the processing apparatus is an MOCVD apparatus for forming the semiconductor layer 12 of FIG. 2 and the characteristic is the leakage current of the GaN-HEMT illustrated in FIG. 3.

In FIG. 2, the formed semiconductor layer 12 is the aluminum nitride nucleation layer 12A, the gallium nitride electron transit layer 12B, and the aluminum gallium nitride electron supply layer 12C. As the source gas, TMA gas, TMG gas, and ammonia gas were used.

FIG. 12 is a diagram illustrating an arrangement order of wafers in the prediction example. As illustrated in FIG. 12, in the susceptor 42, six wafers 40 are arranged on the inner periphery and twelve wafers 40 are arranged on the outer periphery. The arrangement order is numbered counterclockwise from “1” on the inner circumference, and is numbered counterclockwise from “7” which is outside “1”.

### (Prediction Model)

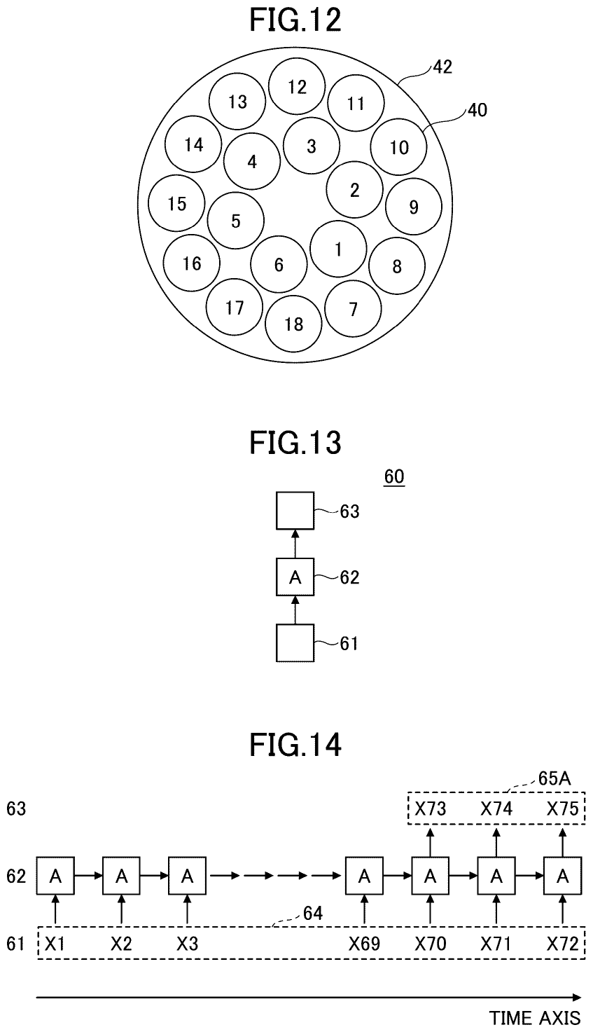

FIG. 13 is a diagram illustrating a prediction model used in the prediction example. As illustrated in FIG. 13, a prediction model 60 includes an input layer 61, a hidden layer 62, and an output layer 63. The prediction model 60 includes an LSTM model, and is the trained model generated using the trained model generation apparatus. The trained model has been generated using the training data in which the serial numbers are associated with the characteristics in 21,963 wafers.

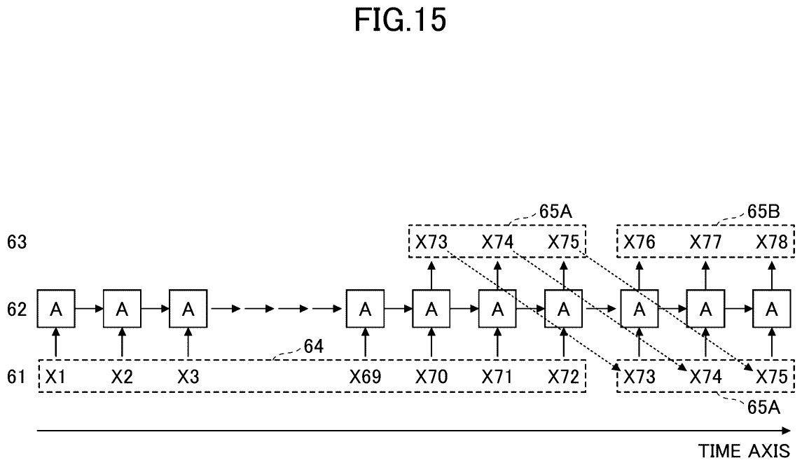

FIG. 14 and FIG. 15 are diagrams each illustrating the processing of the prediction model in the time series in the prediction example. This is an example of inputting input data of 72 wafers. As illustrated in FIG. 14, input data 64 are input to the input layer 61 in the time series. Input data X1 to X72 are characteristics corresponding to the serial numbers 1 to 72. Data 65A output from the output layer 63 when the input data from X70 to X72 are input are set to from X73 to X75. The data from X73 to X75 are data obtained by predicting the characteristics with the serial numbers of 73 to 75.

The prediction model 60 is machine-learned so that a characteristic corresponding to a serial number three serial numbers after the serial number corresponding to the characteristic input to the input layer 61 is output to the output layer 63.

As illustrated in FIG. 15, after the characteristic of the input data 64 of the serial number 72 is input to the input layer 61, X73 of the data 65A is input to the input layer 61, and then X74 and X75 are input to the input layer 61 in order. When the data 65A are input to the input layer 61, data 65B output from the output layer 63 are from X76 to X78. Thereafter, by inputting the data 65B to the input layer 61, data from X79 to X81 are output from the output layer 63. Thereafter, by repeating the above process, the characteristics subsequent to X73 can be predicted.

### (Number of Input Data)

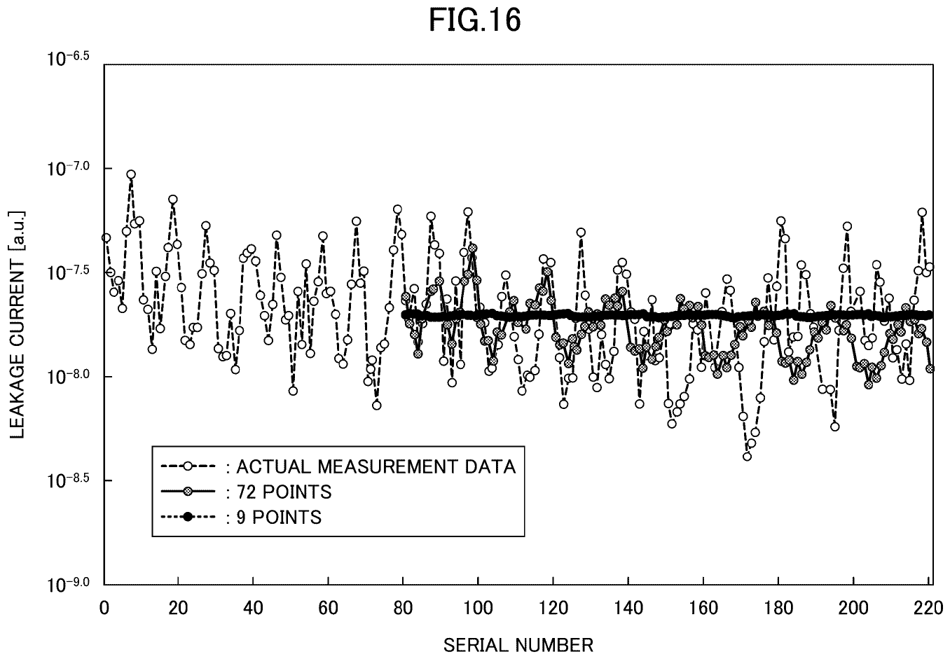

The numbers of data to be input (the number of wafers) were set to 72 points and 9 points, and the leakage currents were predicted. FIG. 16 is a graph indicating a leakage current with respect to a serial number in the prediction example. In FIG. 16, the measured data are actual measurement values of the leakage currents with respect to the serial numbers. The 72 points are data obtained by inputting leakage currents having serial numbers of 1 to 72 as input data and predicting leakage currents having serial numbers of 73 and subsequent serial numbers. The 9 points are data obtained by inputting leakage currents having serial numbers of 64 to 72 as input data and predicting leakage currents having serial numbers of 73 and subsequent serial numbers.

As indicated in FIG. 16, the measured data cannot be predicted with 9 points. With 72 points, up to the serial numbers of about 140, the predicted data are relatively consistent with the measured data, such as positions of peaks and bottoms with respect to the serial numbers.

As described above, by setting the number of pieces of input data to be at least equal to the number of wafers in the batch processing, the predicted data are relatively consistent with the measured data.

### (Arrangement Order)

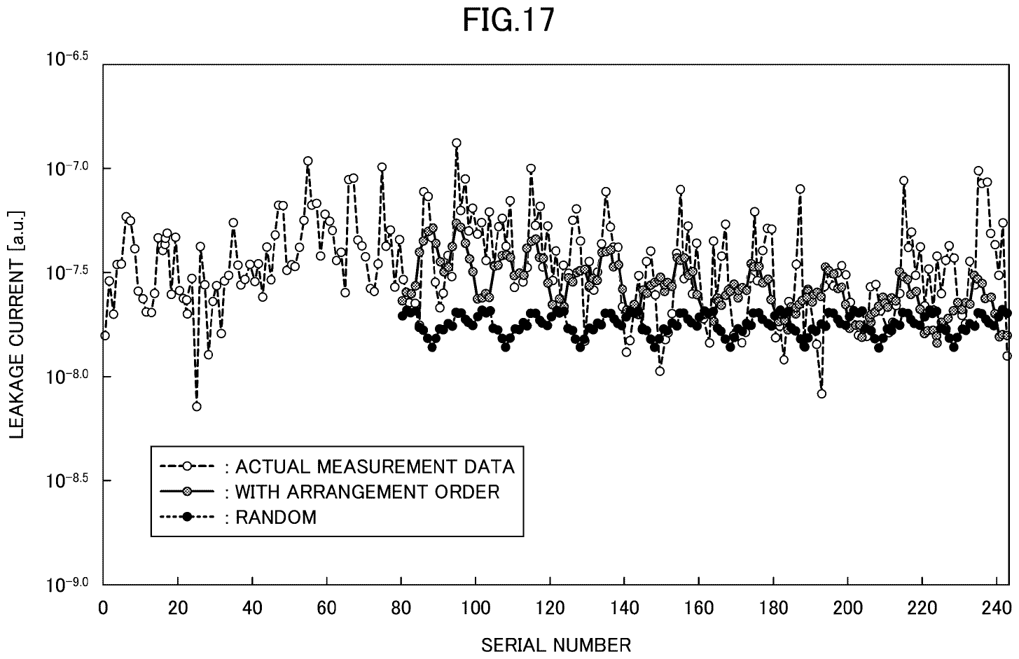

The leakage currents were predicted in the case where the arrangement order in the same processing in the serial numbers was the order of FIG. 12 and in the case where the arrangement order was numbered at random. FIG. 17 is a graph indicating a leakage current with respect to a serial number in the prediction example. In FIG. 17, the measured data are actual measurement values of the leakage currents with respect to the serial numbers. “With arrangement order” is the case where the arrangement order of FIG. 12 is used, and “random” is the case where the arrangement order is set to random. The number of data to be input is 72 points in each case.

As indicated in FIG. 17, the case “random” cannot predict the leakage current after the serial number 73. In the case “with arrangement order”, up to the serial numbers of about 240, the predicted data are relatively consistent with the measured data, such as the positions of peaks and bottoms with respect to the serial numbers.

As described above, in the case “with the arrangement order”, the predicted data are consistent with the measured data, compared to the case “random”.

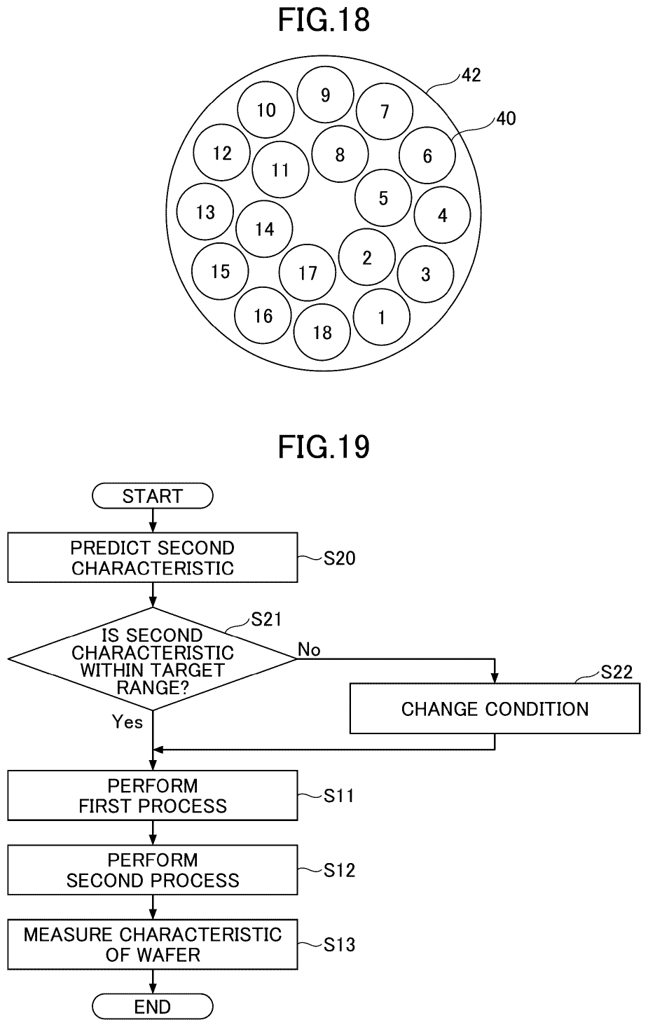

FIG. 18 is a diagram illustrating another example of the arrangement order of wafers. As illustrated in FIG. 18, the arrangement order of the wafers 40 in the susceptor 42 is such that “2” is assigned to the wafer 40 on the inner circumference adjacent to the wafer 40 of “1” on the outer circumference. The wafer 40 on the outer periphery adjacent to the wafer 40 of “2” is denoted by “3”. In this manner, serial numbers may be assigned in the order of angles with respect to the center of the susceptor 42. The serial number may be assigned to adjacent wafers 40 in order among a plurality of adjacent wafers 40.

In the first embodiment, as illustrated in FIG. 7 and FIG. 8, the training data generation unit 52, as the serial numbers, arranges the first processes in the time series, and arranges a plurality of wafers on which the first process is simultaneously executed in each first process among the plurality of first processes in a predetermined arrangement order in the processing apparatus. The training data generation unit 52 sets the training data as data in which the serial number is associated with the characteristic of each of the plurality of wafers measured after the second process is performed on the plurality of wafers on which the first process is performed. The model generation unit 53 acquires training data and performs machine learning on the training data to generate a trained model defining an association between the serial number and the characteristic.

As illustrated in FIG. 9 to FIG. 11, the input data generation unit 57 uses the first serial numbers of the plurality of wafers in the first process executed in the processing apparatus and the measured first characteristics corresponding to the first serial numbers as input data. The prediction unit 58 acquires the input data, inputs the input data into the trained model, and predicts the second characteristic corresponding to the second serial number after the first serial number. The trained model includes a time-series model in which the serial numbers are in the time series. In this way, by inputting the input data including the serial number including the arrangement order in the processing order into the time-series model, the characteristic can be appropriately predicted.

The time-series model may include an LSTM, a transformer, or a GRU capable of long-term memory. This makes it possible to store the output corresponding to several processes ago in the processing order, and thus to improve the prediction accuracy of the characteristic.

As illustrated in FIG. 15, in addition to the first serial number (1 to 72) and the first characteristic (X1 to X72), the second serial number (73 to 75) and the second characteristic (X73 to X75) are input into the trained model, and the third characteristic (X76 or later) corresponding to the third serial number (76 or later) after the second serial number is predicted. Thus, the third characteristic of the third serial number after the second serial number can be predicted. As illustrated in FIG. 14 and FIG. 15,

the trained model outputs a characteristic corresponding to a serial number a predetermined number of 2 or more (3 in FIG. 14 and FIG. 15) later with respect to the serial number corresponding to the input characteristic. This can improve the prediction accuracy of the characteristic. The predetermined number can be selected as appropriate so that the prediction accuracy of the characteristic can be improved.

As indicated in FIG. 16, the first serial number (1 to 72) includes a number greater than or equal to the number of wafers (18) on which the processing apparatus simultaneously executes the first process. This can improve the prediction accuracy of the characteristic. From the viewpoint of improving the prediction accuracy, the number of the first serial numbers can be twice or more, or three times or more, the number of wafers to be simultaneously executed.

The processing apparatus is a semiconductor device manufacturing apparatus. In a batch-type semiconductor device manufacturing apparatus, the characteristic may depend on the arrangement position of the wafer. Thus, by predicting the characteristics using the first embodiment, the characteristics of the semiconductor devices can be predicted with high accuracy. Further, in the manufacturing processes of the semiconductor device, many processes are performed from the processing of the wafer using the manufacturing apparatus to the measurement of the characteristic, and it takes a long period of time until the characteristic is measured. Thus, by predicting the characteristics using the first embodiment, it is possible to reduce the occurrence of defective products until the characteristics are measured.

The processing apparatus is an epitaxial growth apparatus. The first process is a process of forming the semiconductor layer 12 (semiconductor epitaxial layer) on the substrate 10. The second process includes processes of forming an electrode on the semiconductor layer 12. The characteristic is an electrical characteristic measured using an electrode. In the epitaxial growth apparatus, the film quality of the semiconductor epitaxial layer depends on the arrangement position of the wafer. Thus, the electrical characteristic depends on the arrangement order of the wafer in the epitaxial growth apparatus. Thus, by predicting the electrical characteristic using the first embodiment, the characteristic of the semiconductor device can be predicted with high accuracy. Also, many processes are performed from the epitaxial growth to the measurement of the electrical characteristic, and it takes a long time to measure the electrical characteristic. Thus, by predicting the characteristic using the first embodiment, it is possible to reduce the occurrence of defective products until the electrical characteristic is measured.

When the semiconductor epitaxial layer includes a nitride semiconductor layer, the electrical characteristic depend on the arrangement order of the wafer in the epitaxial growth apparatus. Thus, by predicting the electrical characteristics using the first embodiment, the characteristics of the nitride semiconductor device can be predicted with high accuracy.

In the first embodiment, the first serial number and the first characteristic are input to the trained model in which the association between the serial number and the characteristic is defined, and the second characteristic corresponding to the second serial number is predicted. In addition to the serial number, the processing condition of the first process may be used as an explanatory function. That is, the second characteristic corresponding to the second serial number and the second process condition may be predicted by inputting the first serial number, the first process condition, and the first characteristic into a trained model that defines an association of the serial number, the process condition, and the characteristic.

### Second Embodiment

A second embodiment is an example of a method of manufacturing a semiconductor device including the characteristic prediction method of the first embodiment. FIG. 19 is a flowchart illustrating a method of manufacturing a semiconductor device according to the second embodiment. As illustrated in FIG. 19, the second characteristic is predicted using the characteristic prediction method of the first embodiment (step S20). It is determined whether or not the second characteristic is within the target range (step S21). When the result is Yes, the processes from the first process (step S11) to the measurement (step S13) are performed without changing the condition of the first process or the second process.

When the result of step S21 is No, the condition of the first process or the second process is changed according to the second characteristic (step S22). The condition includes a substrate temperature, a gas flow rate, a degree of vacuum, or the like. Then, the first process or the second process is performed using the changed condition. The details from the first process to the measurement are the same as those in FIG. 1, and the description thereof is omitted.

According to the second embodiment, as in step S20 of FIG. 19, the characteristic prediction method of the first embodiment is executed to predict the second characteristic corresponding to the second serial number. As in steps S21 and S22, the condition of the first process or the second process is changed based on the predicted second characteristic. In step S11 or S12, the first process or the second process is executed on the wafer corresponding to the second serial number using the changed condition. Thus, when it is predicted that the characteristic is out of the target range before the first process or the second process is performed, the possibility that the characteristic becomes out of the target range can be reduced by changing the condition of the first process or the second process. Thus, the characteristics of the semiconductor devices can be improved.

When the condition of the second process is changed, steps S21 and S22 may be executed between steps S11 and S12.

When the first process is a process of forming the semiconductor layer 12 of FIG. 2, the change of the condition of the first process may be, for example, to perform the first process after cleaning the inside of the chamber of the MOCVD apparatus. As a result, the product in the chamber is removed, and thus the film quality of the semiconductor layer 12 can be initialized. As described above, the condition of the first process may be the condition of the inner surface of the chamber.

The processor may be various processors suitable for control of a computer, such as a

CPU, a graphics processing unit (GPU), a digital signal processor (DSP), a field programmable gate array (FPGA), and an application specific integrated circuit (ASIC). It is noted that, the plurality of physically separated processors may execute the respective processes in cooperation with each other. For example, the processors mounted on a plurality of physically separated computers may execute the processes in cooperation with each other via a network, such as a Local Area network (LAN), a wide area network (WAN), or the Internet.

The program may be installed in the memory from an external server device or the like via the network, or may be distributed in a state of being stored in a recording medium such as a CD-ROM, a DVD-ROM, or a semiconductor memory and installed in the memory from the recording medium.

The embodiments disclosed herein are to be considered in all respects as illustrative and not restrictive. The scope of the present disclosure is defined by the appended claims rather than by the foregoing description, and all changes that come within the meaning and range of equivalency of the claims are intended to be embraced therein.

What is claimed is:

1. A characteristic prediction method comprising:
acquiring a trained model defining an association between a serial number and a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed; and
inputting, into the trained model, first serial numbers of a plurality of wafers in the first process executed by the processing apparatus and measured first characteristics corresponding to the first serial numbers to predict second characteristics corresponding to second serial numbers after the first serial numbers, wherein
the trained model includes a time-series model using the serial number as a time series.

2. The characteristic prediction method according to claim 1, wherein the time-series model includes a long short-term memory (LSTM) model, a Transformer model, or a gated recurrent unit (GRU) model.

3. The characteristic prediction method according to claim 1, further comprising inputting, into the trained model, the first serial numbers, the second serial numbers, the first characteristics, and the second characteristics to predict third characteristics corresponding to third serial numbers after the second serial numbers.

4. The characteristic prediction method according to claim 1, wherein the trained model outputs a characteristic corresponding to a serial number a predetermined number of 2 or more later with respect to a serial number corresponding to an input characteristic.

5. The characteristic prediction method according to claim 1, wherein a number of the first serial numbers is greater than or equal to a number of wafers on which the first process is executed by the processing apparatus simultaneously.

6. The characteristic prediction method according to claim 1, wherein the processing apparatus is a semiconductor device manufacturing apparatus.

7. The characteristic prediction method according to claim 1, wherein
the processing apparatus is an epitaxial growth apparatus,
the first process forms a semiconductor epitaxial layer on a substrate,
the second process includes forming an electrode on the semiconductor epitaxial layer, and
the characteristic is an electrical characteristic measured using the electrode.

8. The characteristic prediction method according to claim 7, wherein the semiconductor epitaxial layer includes a nitride semiconductor layer.

9. A method of manufacturing a semiconductor device, the method comprising:
performing the characteristic prediction method according to claim 1;
changing a condition of the first process or the second process based on the second characteristics; and
executing the first process or the second process on wafers corresponding to the second serial numbers by using the changed condition.

10. Anon-transitory computer-readable recording medium having stored therein a characteristic prediction program for causing a computer to perform:
acquiring a trained model defining an association between a serial number and a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed; and
inputting, into the trained model, first serial numbers of a plurality of wafers in the first process executed by the processing apparatus and measured first characteristics corresponding to the first serial numbers to predict second characteristics corresponding to second serial numbers after the first serial numbers, wherein
the trained model includes a time-series model using the serial number as a time series.

11. A characteristic prediction apparatus comprising:
a processor; and
a memory storing program instructions that cause the processor to:
acquire a trained model defining an association between a serial number and a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed; and
input, into the trained model, first serial numbers of a plurality of wafers in the first process executed by the processing apparatus and measured first characteristics corresponding to the first serial numbers to predict second characteristics corresponding to second serial numbers after the first serial numbers, wherein the trained model includes a time-series model using the serial number as a time series.

12. A trained model generation method comprising:
acquiring training data in which a serial number is associated with a characteristic, the serial number being based on a time-series arrangement of a plurality of first processes executed by a processing apparatus and based on an arrangement order of a plurality of wafers on which a first process is to be simultaneously executed in each of the plurality of first processes, the arrangement order of the plurality of wafers being determined in the processing apparatus, the processing apparatus being configured to arrange the plurality of wafers and simultaneously execute the first process, and the characteristic being measured in each of the plurality of wafers after a second process different from the first process is executed on the plurality of wafers on which the first process has been executed; and
by performing machine learning on the training data, generating a trained model for predicting, by receiving an input of first serial numbers of a plurality of wafers in the first process executed by the processing apparatus and measured first characteristics corresponding to the first serial numbers, second characteristics corresponding to second serial numbers after the first serial numbers, wherein
the trained model includes a time-series model using the serial number as a time series.
